(19) United States
(12) Patent Application Publication
(10) Pub. No.: US 2016/0181853 A1
(43) Pub. Date: Jun. 23, 2016

(54) LOW EMISSION COIL TOPOLOGY FOR WIRELESS CHARGING

(71) Applicant: Intel Corporation, Santa Clara, CA (US)

(72) Inventors: Songnan Yang, San Jose, CA (US); Emily B. Cooper, San Francisco, CA (US); Essam Elkhouly, Santa Clara, CA (US); Janardhan Koratikere Narayan, Fremont, CA (US); Sheng Ren, Shanghai (CN)

(73) Assignee: INTEL CORPORATION, Santa Clara, CA (US)

(21) Appl. No.: 14/672,082

(22) Filed: Mar. 27, 2015

Related U.S. Application Data
(60) Provisional application No. 62/096,264, filed on Dec. 23, 2014.

(51) Int. Cl. H02J 7/02; H01F 38/14

(52) U.S. Cl. CPC H02J 7/025; H01F 38/14

(57) ABSTRACT

The disclosure generally relates to a method and apparatus for reducing or substantially eliminating, the electric field above a wireless charging station, in one embodiment, a wireless charging station is formed from a length of conductive wire forming a multi turn spiral coil having a plurality of turns around one or more axis. A plurality of discrete capacitors are selected, and positioned at each of the respective plurality of turns. The plurality of discrete capacitors may be connected in series. The capacitance value of each of the plurality of capacitors may be selected to substantially reduce the electric filed above the surface of the charging station.

### BACKGROUND

The instant application claims priority to Provisional Application No. 62/096,264, filed Dec. 23, 2014, the specification of which is incorporated herein in its entirety.

### FIELD

The disclosure relates to a method, apparatus and system to wireless charging station. Specifically, the disclosed embodiments provide improved charging stations for lower electric field emission.

### DESCRIPTION OF RELATED ART

Wireless charging or inductive charging uses a magnetic field to transfer energy between two devices. Wireless charging can be implemented at a charging station. Energy is sent from one device to another device through on inductive coupling. The inductive coupling is used to charge batteries or run the receiving device.

Wireless induction chargers use an induction coil to generate a magnetic field from within a charging base station. A second induction coil in the portable device receives power from the magnetic field and converts the power back into electrical current to charge the battery of the portable device. The two induction coils in proximity form an electrical transformer. Greater distances between sender and receiver coils may be achieved when the inductive charging system uses resonant inductive coupling. Resonant inductive coupling is the near field wireless transmission of electrical energy between two coils that are tuned to resonate at the same frequency.

While a wireless charging coil generates the magnetic field for power transfer, it also generate electric field as a byproduct, which leads to increased electromagnetic radiation, electric shock and electromagnetic, interference (EMI) with sensors of the device being charged (e.g., touch pad, touch screen etc.) There is a need for improved wireless charging coils to reduce the generated electric field, electromagnetic and radio interference while enhancing safety.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1(A) shows a conventional multi-turn wireless charging coil;

FIG. 1(B) shows an equivalent circuit diagram for the wireless charging coil of FIG. 1(A); and

FIG. 1(C) shows a current flow with parasitic shunt capacitor in the circuit of FIG. 1(B);

FIG. 2 illustrates a tuned conventional multi-turn coil having one tuning capacitor at the input;

FIG. 3 is an equivalent circuit model for the conventional coil of FIG. 2;

FIG. 4 is a simplified representation of the circuit of FIG. 3;

FIG. 5(A) shows the simulated input impedance of the circuit of FIG. 4;

FIG. 5(B) shows the voltage distribution at different points of the coil FIG. 4;

FIG. 6 illustrates an exemplary coil design according to one embodiment of the disclosure;

FIG. 7 is a simplified representation of the equivalent circuit model of one embodiment of the disclosure shown in FIG. 6;

FIG. 8(A) shows simulated voltage distribution among nodes V₁˜V5 in the equivalent circuit of FIG. 7;

FIG. 8(B) shows a coil-current comparison between current in a conventional coil configuration (FIG. 2) and a coil layout of the disclosure with inline capacitances (FIG. 6);

FIG. 9(A) shows a conventional coil with one capacitor at the coil input:

FIG. 9(B) shows a low E-filed design with capacitors added to each turn according to one embodiment the disclosure;

FIG. 10(A) shows comparison of measured near field for E-Field of the coils of FIGS. 9(A) and 9(B);

FIG. 10(B) shows comparison of measured near field for H-Field of the coils of FIGS. 9(A) and 9(B);

FIG. 11(A) shows the measured resistance shift comparison between a conventional coil and the disclosed coil designs when approached by lossy dielectric;

FIG. 11(B) shows the measured reactance shift comparison between a conventional coil and the disclosed coil designs when approached by lossy dielectric;

FIG. 12 shows measured Electromagnetic Interference (EMI) profile of transmitter circuit with convention coil (a) horizontal, (b) vertical, with proposed coil solution (c) horizontal, vertical;

FIG. 13(A) shows a conventional coil construction of FIG. 9(A) configured to provide a substantially uniform H-Field;

FIG. 13(B) is a graph showing three components of electric field of a cross-section of the coil in FIG. 13(a);

FIG. 13(C) is a three-dimensional (3D) plot of the graph of FIG. 13(B);

FIG. 13(D) is a side view of FIG. 13(A) showing current variation (represented by different heights) on the surface of the coil of FIG. 13(A);

FIG. 14(A) illustrates an exemplary coil design with tuning capacitors according to one embodiment of the disclosure (e.g., FIG. 9(B)) as well as the capacitance value of in-line capacitors;

FIG. 14(B) illustrates side view of current flowing through the coil of FIG. 14(A);

FIG. 14(C) is a three-dimensional illustration of the electric (Ez) field through a coil;

FIG. 14(D) shows the E-Field cut for an exemplary implementation where z=6 mm, x=0; and

FIG. 15 shows an exemplary block diagram showing an optimization algorithm according to one embodiment of the disclosure.

### DETAILED DESCRIPTION

Conventional A4WP-based wireless charging systems operate at about 6.78 MHz. The power transmitting unit (PTU) roil of such charging systems usually require multi-turn spirals to provide the magnetic field uniformity and the coupling needed to power receiving unit (PRU). A significant challenge in PTU coil design, particularly for large active areas, is that the coil will present much higher losses due to the higher self-capacitance accumulated at the coil.

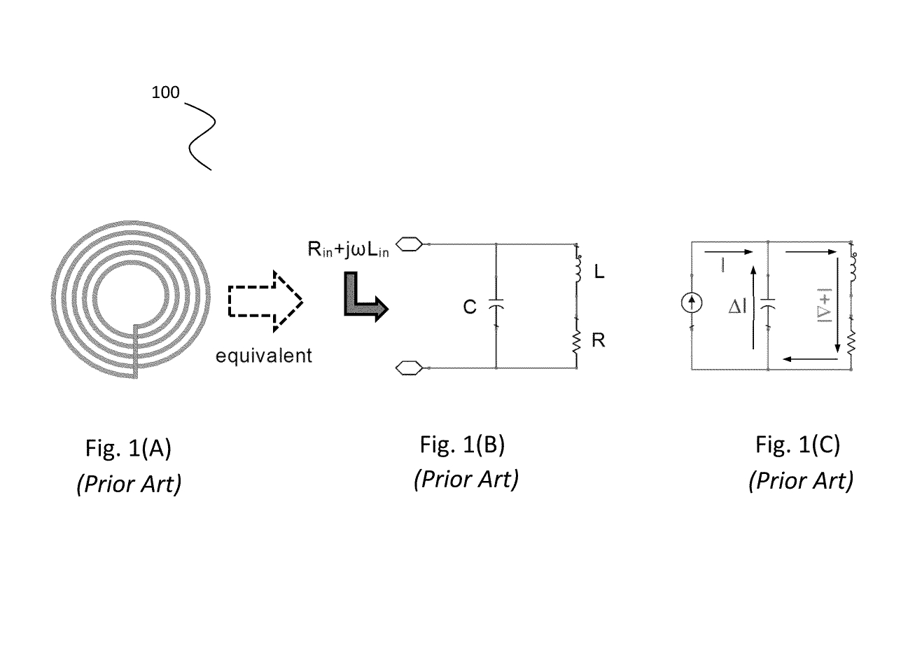

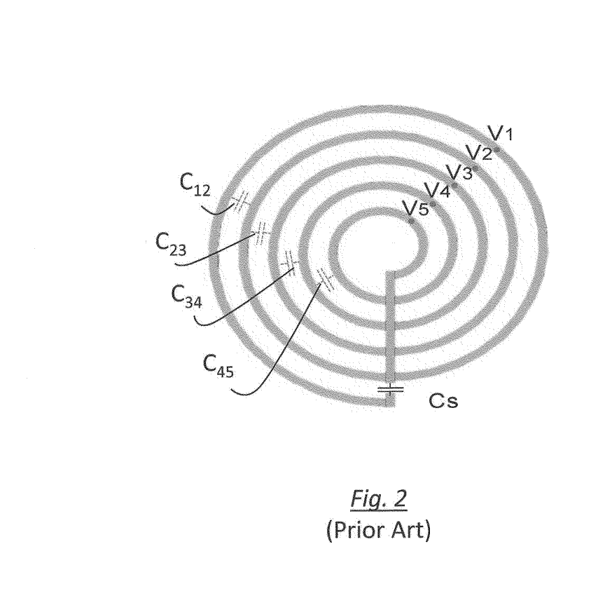

FIG. 1(A) shows a conventional multi-turn wireless charging coil. FIG. 1(B) shows a simplified equivalent circuit diagram for the charging coil of FIG. 1(A). The coil circuit of FIG. 1(A) accumulates self-capacitance, C, as current traverses through the coil. In FIG. 1(B), self-capacitance represents the combination of capacitance among the multitude of turns of the coil; L represents the total inductance of a multi-turn coil; and R represents the combination of radiation and ohmic resistances of the coil. After the introduction of self-capacitance C, the equivalent resistance and reactance of this parallel LC circuit shown in FIG. 1(B) can be described by the Equations (1) and (2), respectively:

$$\begin{matrix}{R}_{in} = \frac{R}{{ω}^{4} {L}^{2} {C}^{2} + {ω}^{2} ( {R}^{2} {C}^{2} - 2 LC ) + 1} & ( 1 ) \\ {L}_{in} = \frac{L - {ω}^{2} {L}^{2} C - {CR}^{2}}{{ω}^{4} {L}^{2} {C}^{2} + {ω}^{2} ( {R}^{2} {C}^{2} - 2 LC ) + 1} & ( 2 )\end{matrix}$$

When the coil LC combinations has a resonant frequency much lower than the operating frequency ω, the equivalent resistance and inductance looking into the parallel LC circuit can be simplified as follows:

$$\begin{matrix}{R}_{in} \approx \frac{R}{1 - 2 {ω}^{2} LC} > R & ( 3 ) \\ {L}_{in} \approx \frac{L}{1 - 2 {ω}^{2} LC} > L & ( 4 )\end{matrix}$$

As shown in Equations (3) and (4), a small shunt capacitance acts as a multiplier for both the coil inductance and resistance. Adding a small parallel capacitor allows a secondary path for current to follow in a direction opposite to the current in inductor L. Thus, when the combined circuit is driven by a constant current source (such as in most A4WP wireless charging systems), the current (I+ΔI) through the L and R is higher than input current (I) which accounts for the increase in equivalent resistance and inductance. This relationship is represented in FIG. 1(C).

In addition, to the intended magnetic field (H-Field) which may be used for power transfer, the self-capacitance build up introduces a strong Electric field (E-Field) in areas near the PTU coil (the near field). The mixing (and unwanted) E-Field on PTU coil couples to PRU device and causes interference to sensors (such as touch sensors, touch screens etc.). The strong E-field may also cause electric shock when the user touches PRU devices. The unwanted E-field on PTU coil also generates significant radiation that hinders the electromagnetic compatibility (EMC) regulatory approval of PTU system. The augmented E-Field makes or tuning the PTU coil highly susceptible to proximity of foreign objects thereby making the PTU system unstable. Typical foreign objects include dielectric material such as a table surface or the human body. Conventional wireless charging, coil designs are limited by the self-capacitance buildup. The self-capacitance buildup limits position flexibility and power transfer distance.

The disclosed embodiments provide method and system for diminishing the self-capacitance phenomenon common to conventional PTU coils. In an exemplary embodiment, one or more capacitive tuning component is placed strategically along a multi-turn charging coil design to reduce the impact of self-capacitance among multitude of turns of the coil.

In one embodiment, the capacitive tuning component resonates each coil turn individually to avoid AC from accumulating among adjacent turns of the coil. The capacitive tuning component minimizes E-Field generation while keeping intact the near field H-Field. The disclosed embodiments also reduce the EMI and RF interference (RFI) emissions, minimize the risk of electric shock to a user and mitigates interference to PRU touch sensors.

In another embodiment, the disclosure provides a prices for low emission, robust, coil design to optimize the coil. The optimization enables current distribution flatness throughout the coil to thereby minimize the E-Field generation.

In still another embodiment, a capacitor is added at the center of the length of the spiral coil to provide the maximum effect of reducing the E-Field as compared with adding one or more capacitors to each turn of the coil. Thus, only one location at the spiral coil is broken by adding a single capacitor.

FIG. 2 illustrates a conventional multi-turn PTU coil having one tuning capacitor (Cs) at the input. In FIG. 2, voltage at various points of the coil is denoted as V₁, V₂, V₃, V₄ and V₅. Parasitic capacitance is formed between each pair of adjacent coil wires and is denoted by dashed capacitors C₁₂, C₂₃, C₃₄ and C₄₅. These capacitors are parasitic capacitance and may inherently exist in the conventional coil design. In one embodiment, the disclosure adds series capacitance (and capacitive elements) to mitigate the effect of the parasitic capacitances. The capacitive elements may be added in line with the coil.

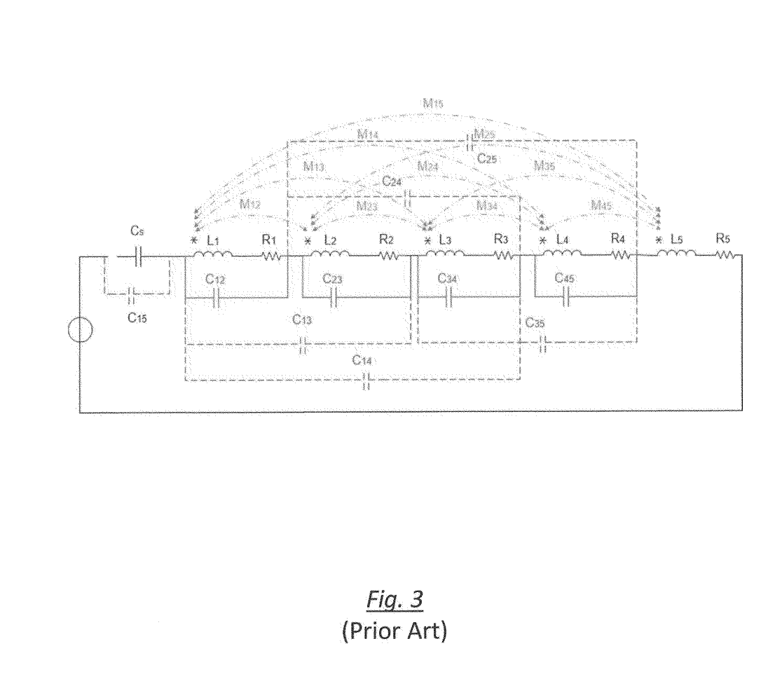

The equivalent circuit model for the coil of FIG. 2 is shown at FIG. 3, where each individual turn is represented by an inductor Ln and a resistor Rn, the equivalent circuit of each turn is then connected in series to represent the entire coil. Capacitance between successive turns (Cmn) is added to the model in shunt among turns. Mutual inductance among coil turns are represented by Mmn in the equivalent circuit of FIG. 3.

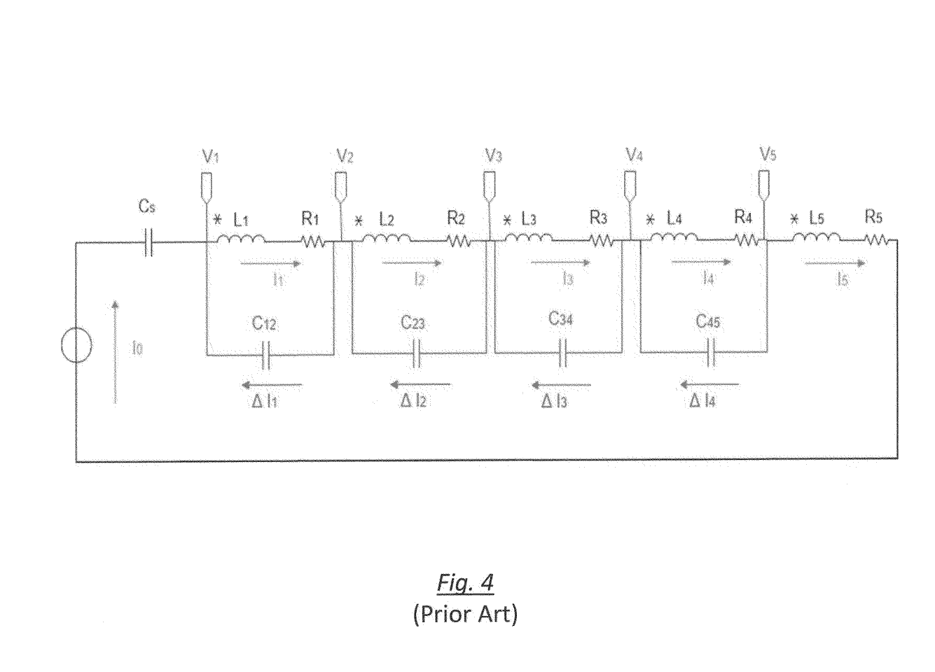

The equivalent circuit model of FIG. 3 may be simplified by omitting the much smaller mutual capacitance among non-adjacent turns. It may also be assumed that all mutual inductance (Mmn) is fully represented by inductance Ln of each turn. The full circuit model in FIG. 3 may be simplified to approximate model circuit depicted in FIG. 4.

The parasitic capacitance (Cₙ₍ₙ₊₁₎) between adjacent turns magnify the inductances and resistances of each turn. Consequently, the combined resistance and inductance is much higher than simple sum of inductance and resistance of each turn. For example, assume L₁=L₂=L₃=L₄=L₅=3 uH, C₁₂=C₂₃=C₃₄=C₄₅=10 pF, R₁=R₂=R₃=R₄=R₅=0.1 Ohm, at A4WP operating frequency of 6.78 MHz.

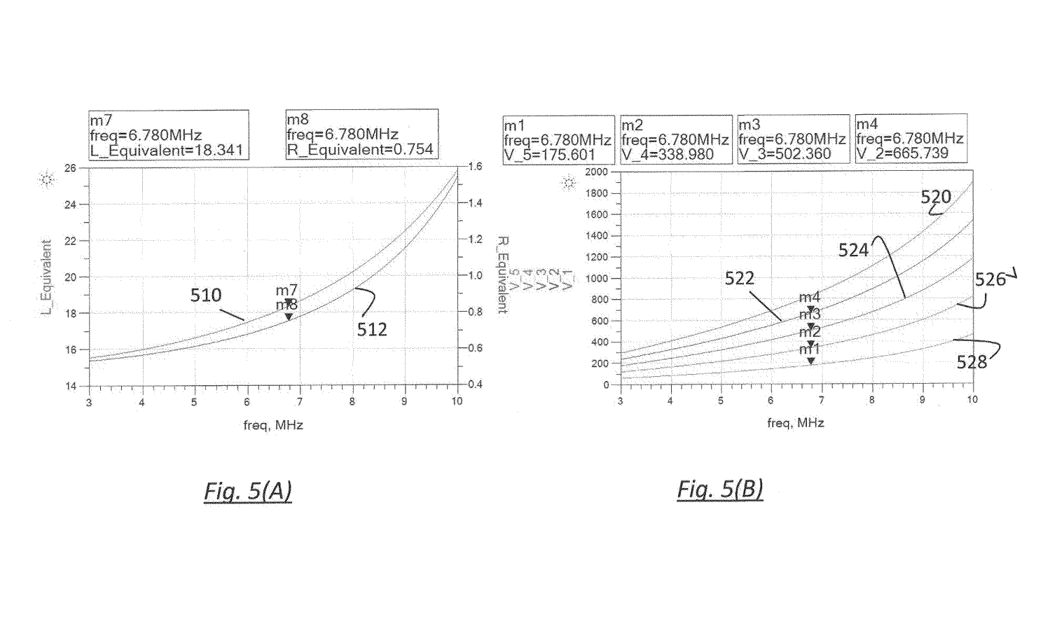

FIG. 5(A) shows the simulated input impedance of the circuit of FIG. 4. Here, both the equivalent inductance 510 and resistance 512 values are much higher than the sum of the value of each turn due to the parasitic capacitance.

When the circuit of FIG. 4 is driven by a constant current AC source (e.g., at I₀=1A), the higher equivalent resistance and inductance of each nice generates a high voltage difference between same locations on adjacent turns of the coil (as indicated in FIG. 3 by V₁-V₅). The simulated voltage of each turn shows gradual buildup of voltage magnitude across the turns of this conventional spiral coil, as shown in FIG. 5(b), where the voltage difference between adjacent turns shows about 160V difference. The high alternating voltage applied to parasitic capacitance between turns (e.g., C₁₂-C₄₅) causes significant near field Electric field, which makes the coil susceptible to detaining by device undercharge and/or foreign objects, it also contributes significantly to far field radiation, cause electrical shock on PRU devices or cause interference to touch sensors and other similar devices. In FIGS. 5(A) and 5(B), each of lines 520 (V₁), 522 (V₂), 524 (V₃), 526 (V₄) and 528 (V₅) shows the relationship between frequency and the voltage of the corresponding point on the coil.

In one embodiment of the disclosure, the high loss and large electric field is substantially diminished by positioning capacitive tuning components at strategically designated locations along the multi-turn coil. The capacitive tuning components (interchangeably, elements) reduce the impact of self-capacitance among the many hums of the coil. In one embodiment of the disclosure, each coil turn resonates individually to thereby prevent voltage buildup among adjacent coil turns. This, in turn, minimizes the electric field generation while keeping the near field H-field intact. The disclosed embodiment also reduces the RFI emission.

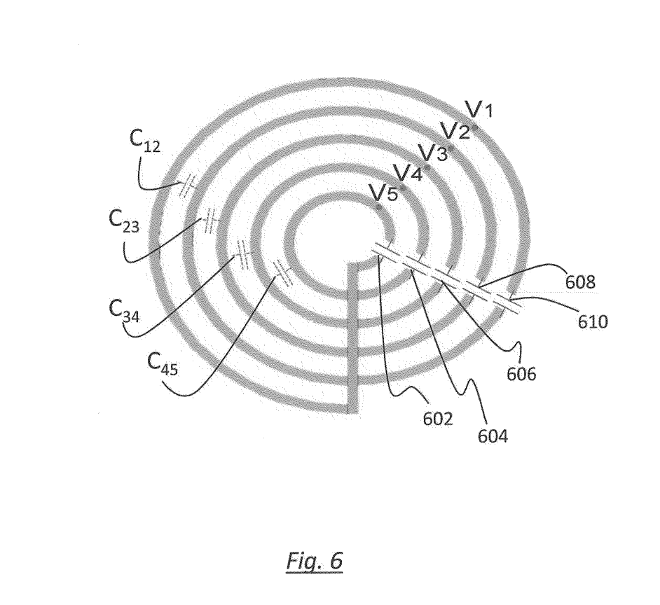

FIG. 6 schematically illustrates an exemplary coil design according to one embodiment of the disclosure. Specifically, FIG. 6 shows a novel coil design with capacitive tuning elements added along each turn. In one embodiment, the tuning elements may be distributed along a cross-sectional line of the coil as shown. The tuning elements may also be distributed throughout different locations of the coil (not shown). In FIG. 6 capacitive elements 602, 604, 606, 608 and 610 are posited between each pair of adjacent coil turns. Through careful selection of the values of the added in line capacitors (Cₛ₁-Cₛ₅), the voltage difference between adjacent turns (e.g., V₁-V₂) may be minimized. As a result, even if the parasitic capacitance (C₁₂, C₂₃ . . . C₄₅) between adjacent turns may still remain, no current would flow across the parasitic capacitance since no voltage is applied across the parasitic capacitances. Consequently, the coil present minimum inductance and resistance.

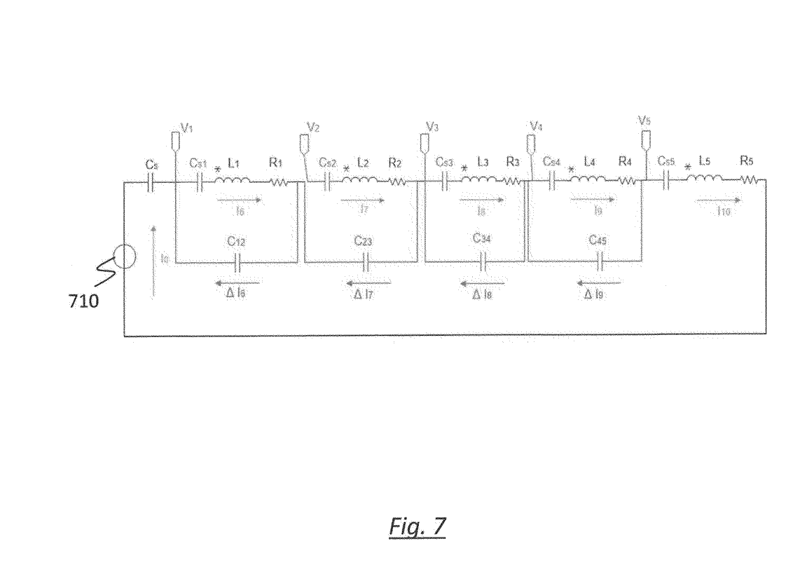

FIG. 7 is a simplified representation of the equivalent circuit model for the circuit of FIG. 6. In FIG. 7, the added inline capacitors (602, 604, 606, 608 and 610) are modelled as tuning capacitances (Cₛ₁-Cₛ₅) added in series of the inductances (L₁-L₅) and resistance (R₁-R₅) representing each turn. For generic coil dimensions, the series tuning capacitances (Cₛₙ) may be optimized through EM simulation, as will be discussed in greater detail below. For simplicity, following the assumption of equal inductance, resistance and parasitic capacitances on each turn (L₁=L₂=L₃=L₄=L₅=3 uH; C₁₂=C₂₃=C₃₄=C₄₅=10 pF; R₁=R₂=R₃=R₄=R₅=0.1 Ohm), the series capacitances needed to resonant the coil on each turn is the same (Cₛ₁=Cₛ₂=Cₛ₃=Cₛ₄=Cₛ₅=˜180 pF). In FIG. 7, Cₛ₁-Cₛ₅ represent inline or series capacitive elements and have substantially equal voltage across each capacitor.

In one embodiment, the added series capacitance cancels out (or tunes out) the equivalent inductance on each turn such that between substantially the same locations along each turn (such as V₁, V₂ . . . V₅ points as shown in FIG. 6) the reactance is zero. This leads to a minimum voltage between substantially same locations along each turn while the coil is driven by a constant current AC source. This condition will also force the current flowing back through parasitic capacitances (ΔI6-ΔI9) to be almost zero and each coil turn will have substantially the same constant current (I₀) as driven by source 710. The zero voltage condition among the coil turns also warrants the near field, electric field, to be minimized. The equivalent whole coil inductance and resistance is a sum of that of each turn (15 uH and 0.5 Ohm in this example) which is significantly less than the conventional coil configuration (results shown in FIG. 5A).

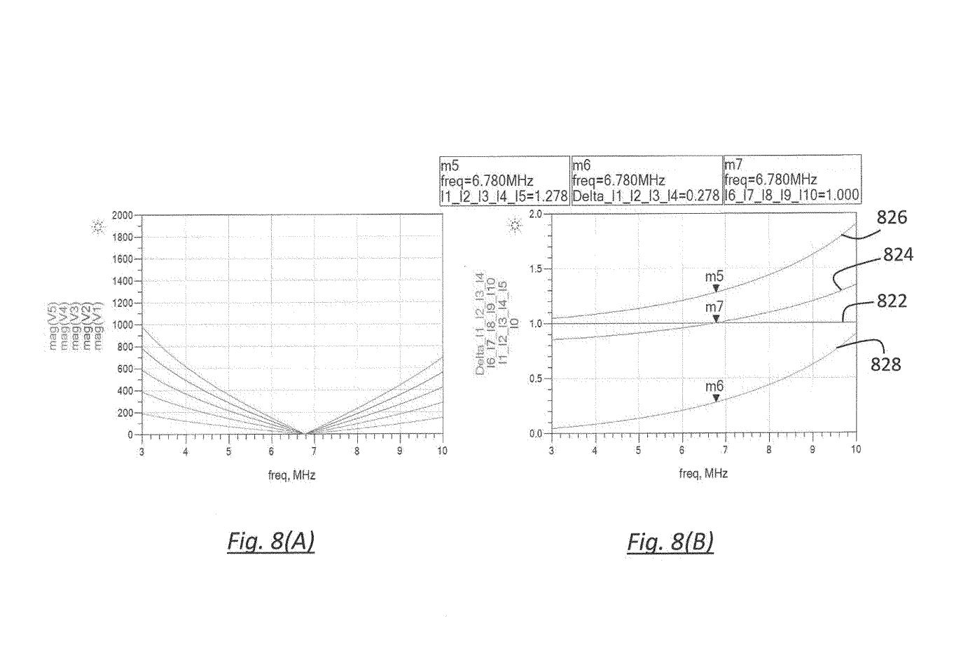

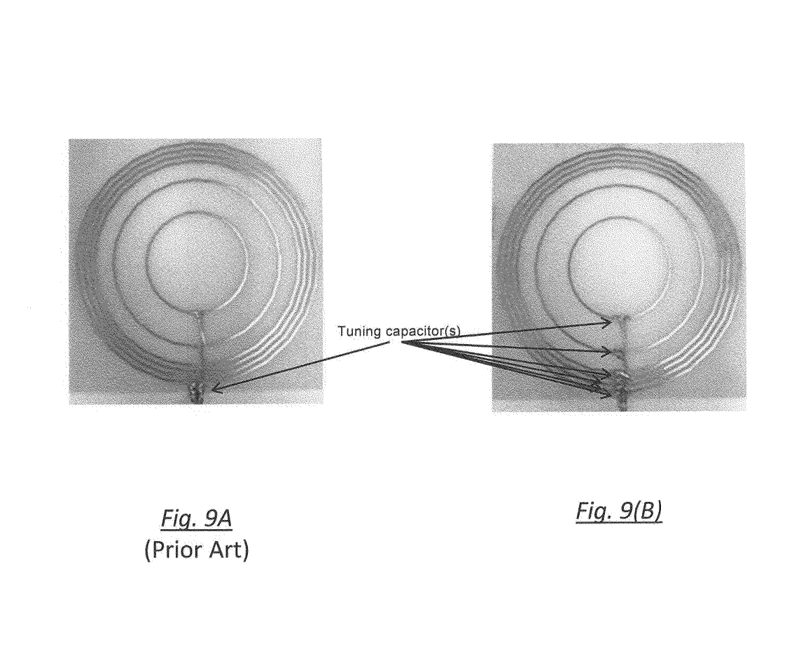

FIG. 8(A) shows simulated voltage distribution among nodes V₁˜V₅ in the equivalent circuit of FIG. 7. It can be seen that with proper selected series tuning capacitances (see FIG. 7) at design frequency of 6.78 MHz, the AC voltage on substantially the same points on each turn of coil is almost zero. The zero voltage produces minimum E-Field on the coil in the near field.

FIG. 8(B) shows a coil current comparison between conventional coil configuration (FIG. 2) and the proposed solution with inline capacitances (FIG. 6). In FIG. 8(B), line 822 is the circuit bias at about 1 Amp: line 824 shows change of current as a function of frequency for the novel circuit of FIG. 6, line 826 shows the same relationship for the conventional coil and line 828 shows the difference between lines 824 and 826. Line 628 represents the additional current that flows on the conventional coil design, which in turn result in higher losses and lower power transfer efficiency.

As seen in FIG. 8(B), the disclosed embodiments are able to maintain substantially the same current flowing through each turn of the coil (I₆˜I₁₀=I₀) by selecting a proper tuning capacitor (Cs). This is a significant improvement over the conventional coil designs which are plagued with higher current at each coil turn (I₁˜I₅˜ΔI₁˜ΔI₅=I₀) caused by the accumulation of parasitic capacitances.

In the above examples, the each-turn-equivalent inductance, resistance and mutual capacitances/inductances are assumed to be equal for simplicity. In practice, and with coils of arbitrary shapes, these values can be calculated through EM simulations.

Comparative prototypes were prepared to show efficacy of the disclosed embodiments over the conventional design. FIG. 9(A) shows a conventional coil and FIG. 9(B) shows a low E-filed design with capacitors added to each coil turn according to one embodiment the disclosure. The coils of FIGS. 9(A) and 9(B) had identical dimensions and were manufactured one with one tuning capacitor at the input of the coil (FIG. 9(A)) while the other included a tuning capacitors added to each mm of the coil (FIG. 9(B)). The coil designs of FIGS. 9(A) and 9(B) were optimized for uniform H-Field distribution at 12 mm away from the coil surface. The optimization caused the uneven distribution of radii of each turn of coil. A low E-Field coil synthesis procedure based on EM simulation and optimization was used to determine the capacitance values to be added along each turn.

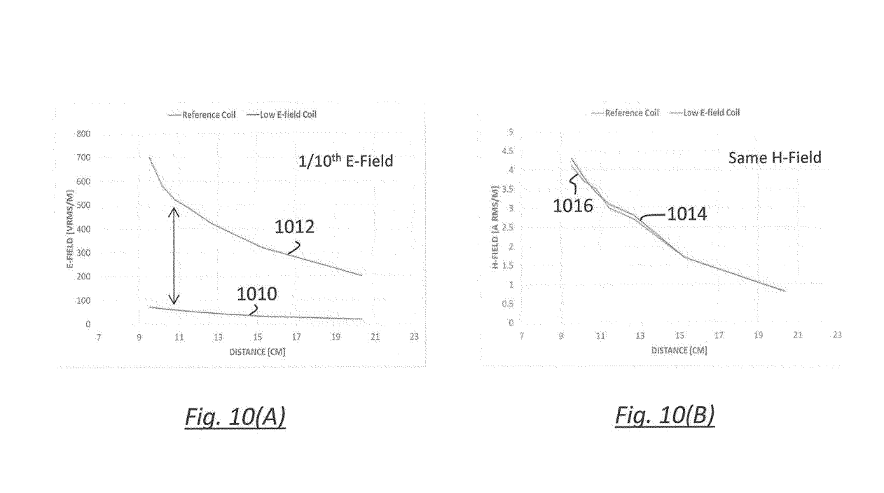

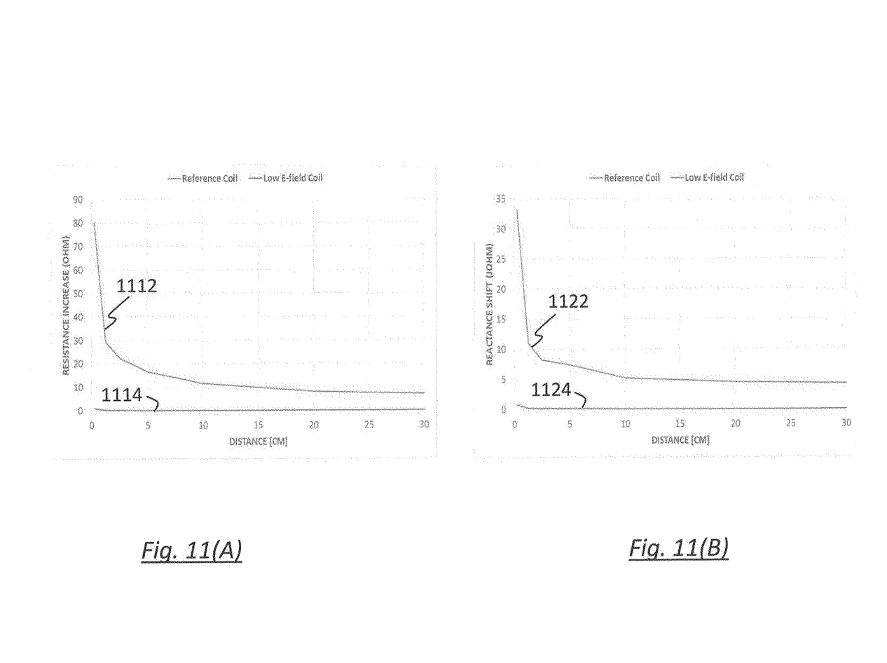

Near Field Measurements—The coils shown in FIGS. 9(A) and 9(B) were tested while connected to the same constant current RF source at 6.78 MHz. Both the near field E-Field and the H-Field were measured using survey probes with separation ranges from 10-20 mm. The results are shown in FIGS. 10(A) and 10(B). Specifically, FIG. 10(A) shows the comparison of measured near field E-Field of the conventional coil (line 1010) and that of the disclosed design (line 1012). FIG. 10(B) shows the comparison of measured H-Field of the conventional coil (line 1016) and the disclosed design (line 1014).

As shown in FIGS. 10(A) and 10(B), the measured results illustrate that while providing the same near field H-Field, the proposed low emission robust coil of FIG. 9(B) provides 10 times reduction in near field E-Field. This is a significant improvement in the coil robustness, such that the coil is not easily affected (i.e., de-tuned) by nearby objects including the human body or the device being charged.

To show the improved coil robustness, a series of experiments were carried out where human proximity to the coil was emulated by placing a hand over the coil at different proximities. The measured real resistance and reactance shifts were recorded as shown in FIGS. 11(A) and 11(B). FIG. 11(A) shows the measured resistance shift comparison between a conventional coil and the disclosed coil designs when approached by a lossy dielectric object. FIG. 11(B) shows the measured reactance shift comparison between a conventional coil and the disclosed coil designs when approached by lossy dielectric object. As shown in FIGS. 11(A) and 11(B), the conventional coil exhibits dramatically more variation (100×+) in resistance (line 1112) and reactance (line 1122) in response to the proximity of a human hand. This is due to the presence of strong near field E-Field. The E-field is easily disturbed when a material of high dielectric constant (e.g., human hand) is in its proximity. The significant change in coil impedance (line 1112) with hand 10 mm or closer renders the coil unusable.

In contrast, the proposed coil structure (FIG. 11(B)) shows almost no change in the coil impedance (lines 1114, 1124) which makes the disclosed embodiments substantially immune to a foreign object with high dielectric constant. This is due to the low near-electric bald generated by the exemplary embodiment of FIG. 9(B).

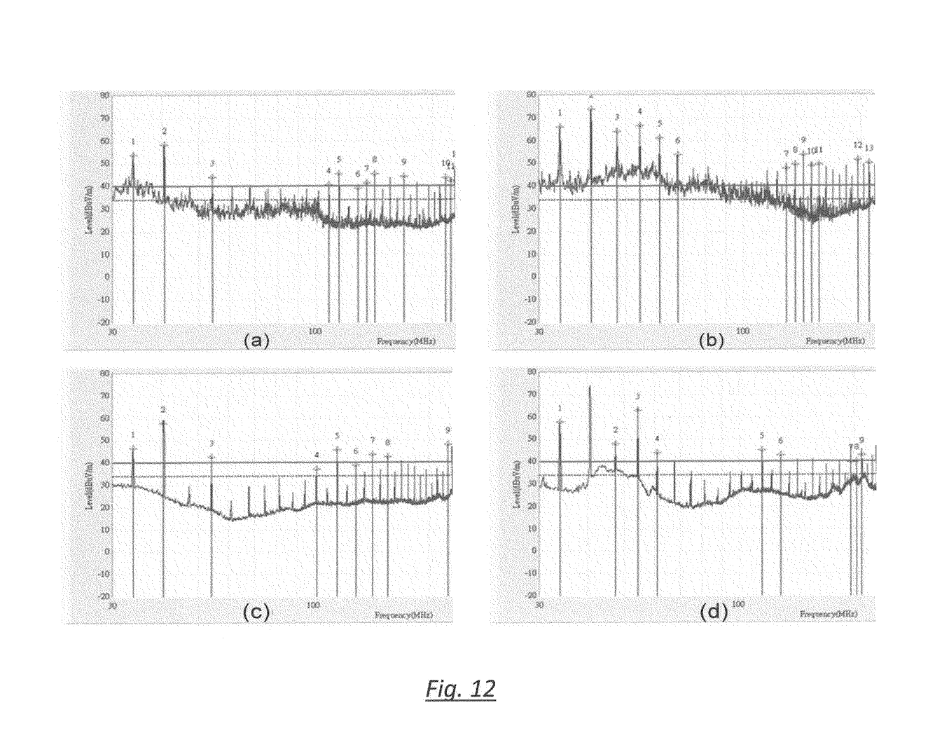

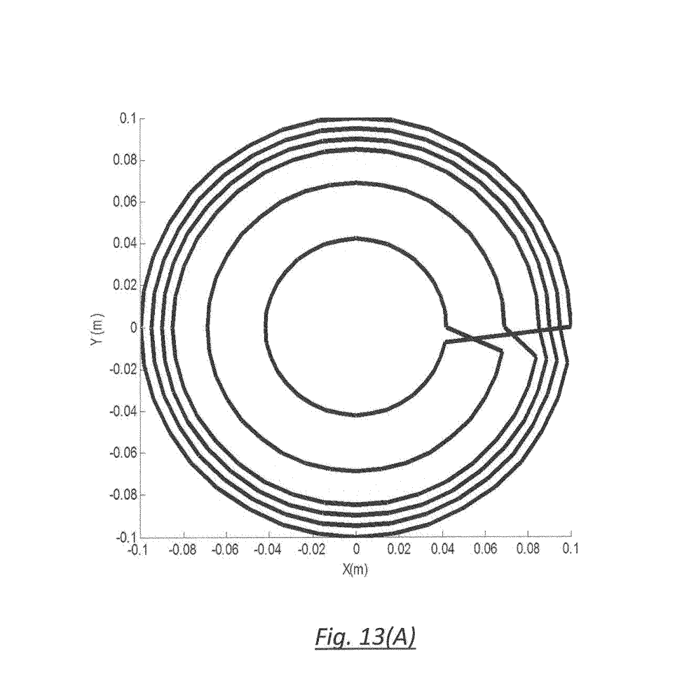

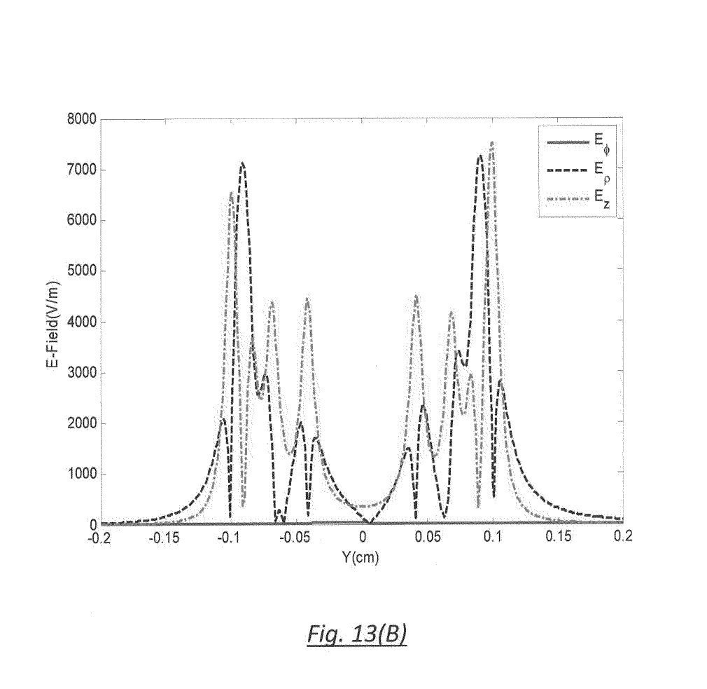

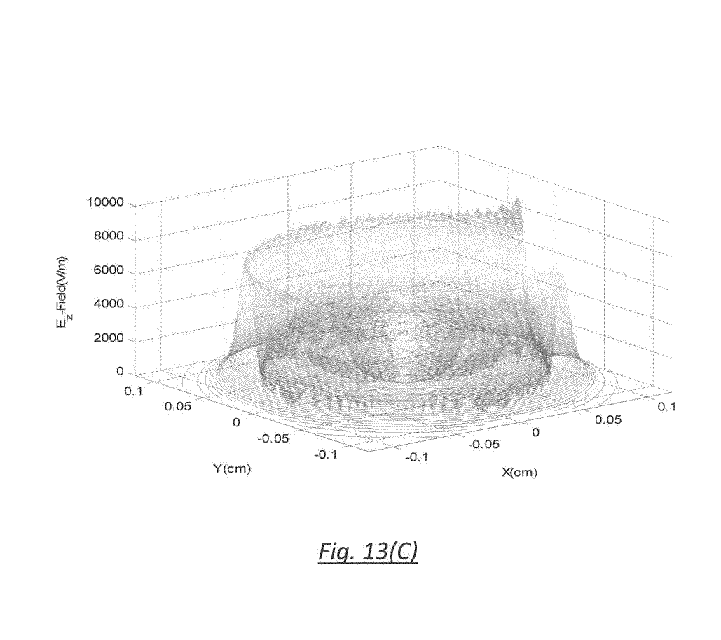

EMI Evaluation Results—Extensive EMI tests were carried out with the same switch mode power amplifier connected to the two coil prototypes shown in FIGS. 9(A) and 9(B). The power amplifier circuit had rich harmonic and broadband noise contents and behaved substantially as a constant current source. FIGS. 12(A)-12(D) show comparison results between measured emissions of the two exemplary coil designs.

Specifically, FIGS. 12(A)-12(D) show measured EMI profile of transmitter circuit with convention coil (FIG. 12(A)) horizontal, (FIG. 12(B)) vertical, with proposed coil solution (FIG. 12(C)) horizontal, (FIG. 12(D)) vertical. It can be seen that emission profile of conventional coil design (i.e., graphs of FIGS. 12(A) and 12(B)) show significantly higher (10+ dB) noise (both noise floor and harmonics of 6.78 Mhz) compared with the low emission coil structure design disclosed herein graphs of FIGS. 12(C) and 12(D)).

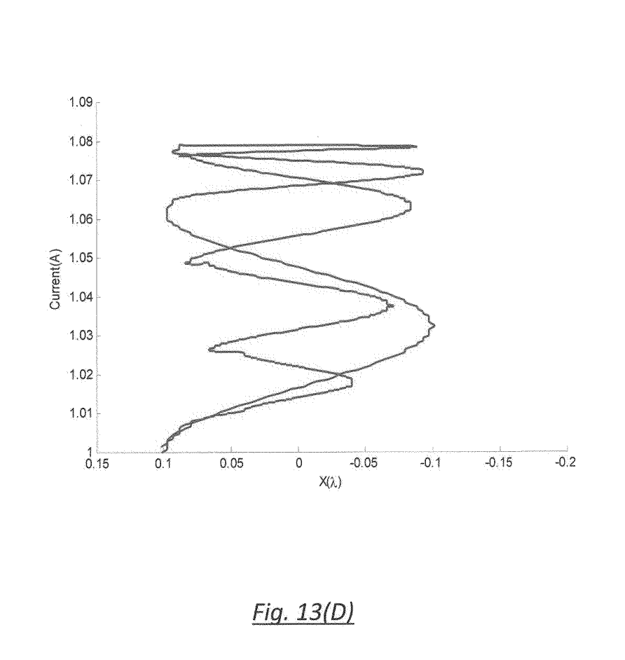

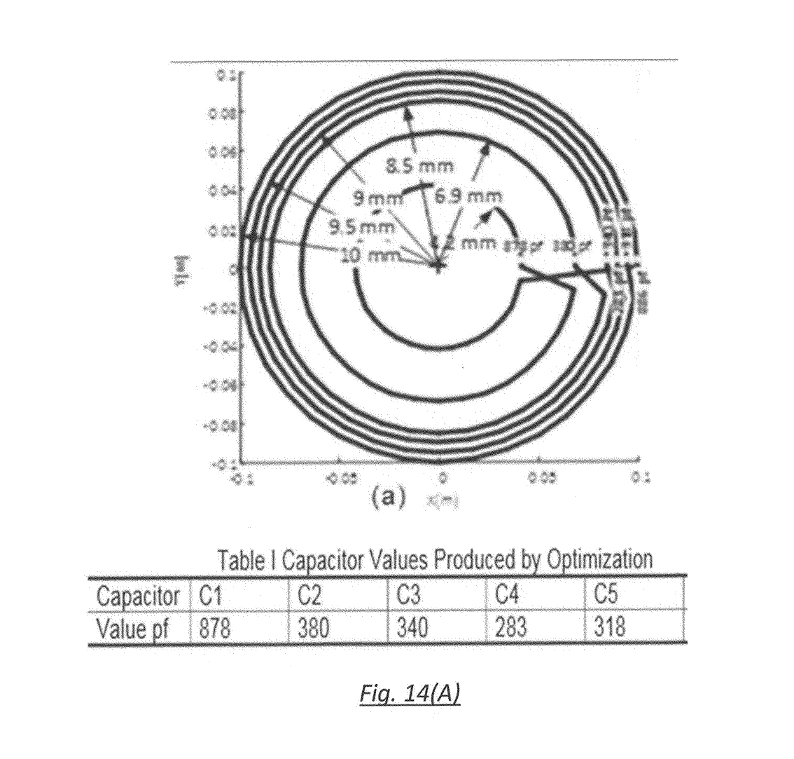

In certain embodiments, the disclosure provides a method and apparatus for determining optimal design location of capacitive components of a wireless charging coil. For an exemplary coil that lies in the x-y plane as shown in FIG. 13(a)), the H-Field will be predominantly in the direction. The dimensions of X and Y are in meters. The E-Field in the φ direction is small because it is substantially tangential to the coil wires. High E-Field is noticed in the z and ρ directions. As discussed, the high E-Field causes high emission and degrades the coil robustness. The high E-Field may also cause electric shock on the device under charge (DUC) and cause interference to touch sensor(s) of the DUC.

A coil with low or no accumulated parasitic capacitance has low current variation. This, in turn, limits the E-Field amplitude and makes the coil more robust. In one embodiment of the disclosure, the term robust is used to denote capacity to remain substantially unaffected by surrounding conditions. The surrounding conditions may include, for example, the impacted of a physical object (e.g., a human hand). Tuning one or more of the coil turns eliminates the reactance (inductance) build up inside the coil. The tuning significantly reduces the electric field over the coil's length as well as the unwanted emission.

FIG. 13(a) shows the conventional coil construction designed to provide a uniform H-Field as in 9(a). The coil was simulated using a Method of Moment (MoM) tool, to find current distribution through its turns and to estimate the E-Field. A constant AC current of about 1 Amp was provided to the coil. FIG. 13(b) shows an electric field cut at x=0, z=6 mm, the E-Field in the ρ and z direction are both very strong. In other words, FIG. 13(b) shows three components of the E-Field at a cross-section of the coil of FIG. 13(a).

The three-dimensional E_{z} field is shown in FIG. 13(e), with a maximum value of about 9000 V/m. The current distribution is plotted in FIG. 13(d) where the current variation is about 8% for the simulated structure. Thus, FIG. 13(d) illustrates current distribution at a side view of FIG. 13(a), showing current variation (represented by different heights) on the surface of the coil of FIG. 13(a).

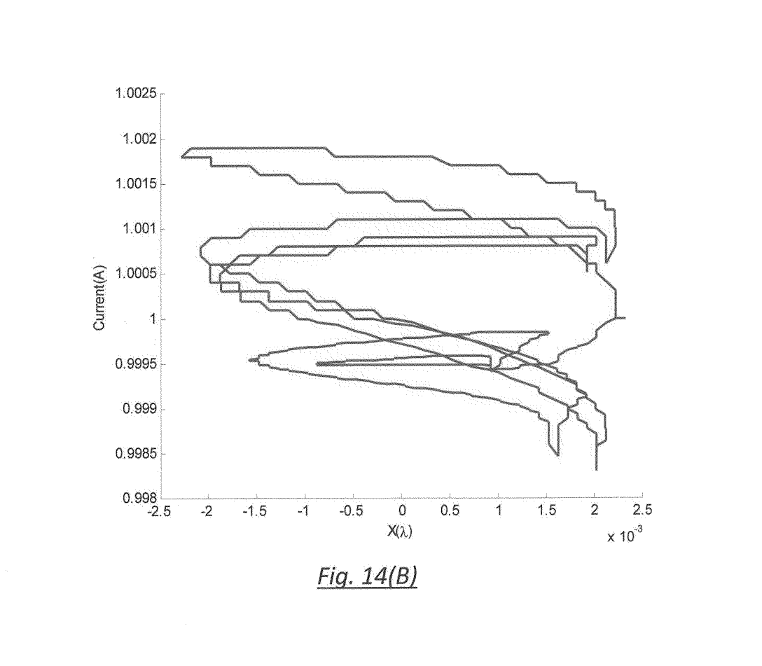

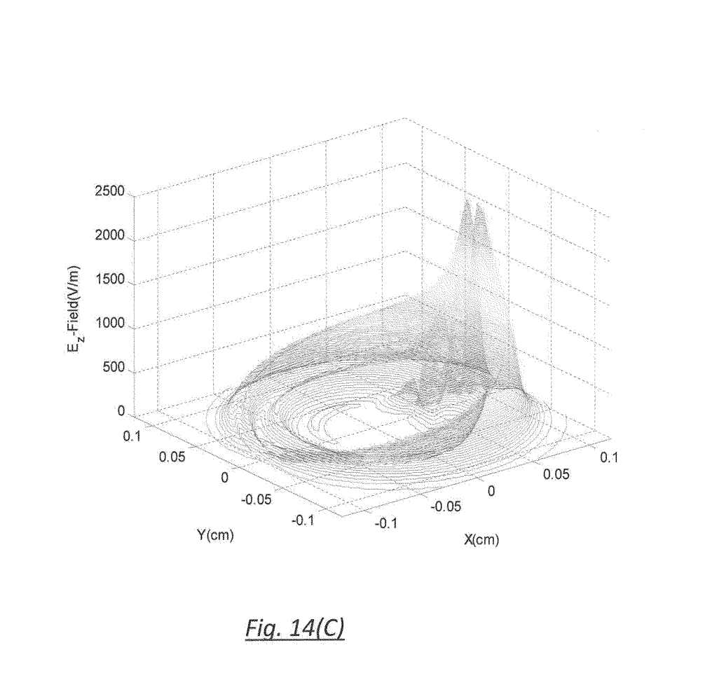

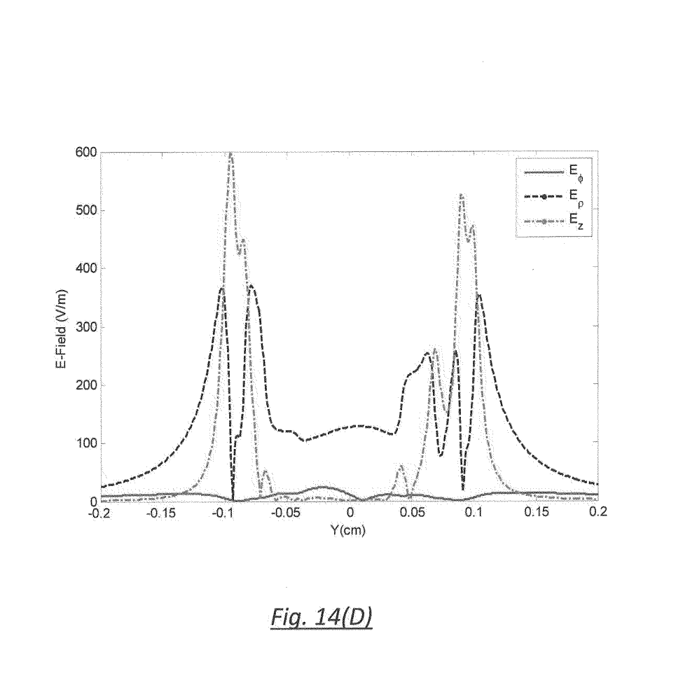

The measurements of FIGS. 13(a)-13(d) were repeated with a coil, designed according to the principles disclosed herein. As shown in FIG. 14(A), the modified coil has substantially the same dimensions for each turn as the design shown in FIG. 13(A). Capacitors with various capacitance values (as shown in the Table of FIG. 14(A)) were added in series along each coil turn. The capacitor values were derived using genetic algorithm-based optimization. FIG. 14(D) shows the E-Field alter adding a capacitor at each turn (as shown in FIGS. 6 and 9(B)). The value of the ρ and z direction E-Field were reduced to 1/12 of the value of conventional construction discussed earlier. In the meantime, the current variation along the entire coil was just 0.3% as shown in FIG. 14(B). FIG. 14(C) illustrates the simulated 3D E_{z} field across the proposed coil structure where the E-field is much lower compared, to conventional coil (without the optimized inline capacitors). High fields were observed near feeding points to the coil, the transition connection between the turns and where the inline capacitors were located.

As an example of the optimization process, a coil that was optimized for z-component of the H-Field uniformity (assuming uniform equal current on the coil loops) was selected for this example. The capacitor locations were selected along one radial cut of the coil (as shown in FIG. 9(B)). The optimum values for the capacitors were derived by an optimization process the optimum values were configured to reduce the E-Field and provide a substantially uniform current along the coil.

In an exemplary implementation, the optimization process was based on the E-Fields components (E_{z} and E_{ρ}) with the goal of minimizing the average value of the combination of these components. Method of moment code was used to predict current in the coil wire and compute the three components (E_{z}, E_{ρ}, and E_{φ}) of the near electric field. MoM was used to solve electromagnetic problems where the unknown current on the wire was represented by known N functions (basis functions) with unknown coefficients/amplitudes. The problem was then tested against the boundary conditions to define a linear system of N equations. The equations were solved numerically to find the basis functions coefficients. The system may be described by Equation (5):

L(f)=g (5)

In Equation (5), L is the linear system an integral operator in this example), f is the unknown current function and g is the excitation source.

Thin wire approximation was used for optimization, where the current is a filament at the center of wire Ī(\grave{r}), \grave{r} is the position vector along the wire carrying the current and the current is a vector in direction tangential to the wire. The linear operator is an integral equation:

$$( 1 + \frac{1}{{k}^{2}} ∇ ∇ . ) \int \overline{I} ( {r}^{‵} ) G ( r , {r}^{‵} ) d {r}^{‵} = - \frac{j}{ωμ} \overline{E} . \hat{I} \qquad ( 6 )$$

The right hand side of Equation (6) is the linear operator and left is the excitation source. G is a Green's function

$$\frac{{e}^{- j kr}}{2 π r}$$

and ∇ is Del, the partial derivative operator. The current is approximated using N weighted basis functions fₙ, they are tangential to the wire everywhere. The linear operator applied on the current is equivalent to applying on the basis function summation.

Ī(\grave{r})≈Σ^{N}aₙfₙ(\grave{r}) (7)

Σ^{N}aₙL(fₙ(\grave{r}))≈g (8)

The integral equation was tested by N testing function fₘ(r), the testing function were the same as the basis function. The integral equation was tested at the boundary conditions (i.e., the wire surface where the tangential field equal zero except at the source segment):

Σ^{N}an<fm, L(fₙ)>=<fₘ, g>Zₘₙ=<fm, L(fₙ)>, bₘ=<fₘ, g>>fₘ, fₙ>=∫_{fm}fₘ∫_{fn}fₙd\grave{r}dr (9)

This operation forms N×N linear equation system Zₘₙaₙ=bₘ that is solved to find aₙ and hence the current. The magnetic and electric fields are found by means of magnetic vector potential A

$$\begin{matrix}A ( r ) = \frac{{μ}_{0}}{4 μ} {\int }_{l} \frac{\overline{I} ( {r}^{‵} ) {e}^{- j k \vert r - {r}^{‵} \vert}}{\vert r - {r}^{‵} \vert} d {r}^{‵} & ( 10 ) \\ H = \frac{1}{{μ}_{0}} ∇ \times A & ( 11 ) \\ E = \frac{1}{{jωε}_{0}} ∇ \times H & ( 12 )\end{matrix}$$

The optimization process starts with initial values for the capacitors (i.e., initial population). MoM was used to calculate the electric field components at the observation points of z₀=6 mm, x₀=0 for one cut to expedite the optimization time. The cost function that the optimization algorithm tries to minimize is the mean value of the E_{ρ}, and E_{z} values. A genetic algorithms employed to control the optimization: it changes the values of the capacitors and stores the correspondent cost function. In one embodiment, the optimization stops when the cost function value is not improving.

In an exemplary embodiment, the coil was included with six capacitors, one capacitor for each loop. The capacitor values, C={c₁, c₂, . . . , c₆}, are the optimization variables. The optimization problem may be defined as

arg_{c} min(mean(E_{φ}, E_{z}) at (xₒ, yₒ, zₒ)) (13)

xₒ=0, −12 cm<yₒ<12 cm, zₒ=6 mm (14)

In the above equations, xₒ, yₒ, and zₒ are the observation points, where the electric field is minimized.

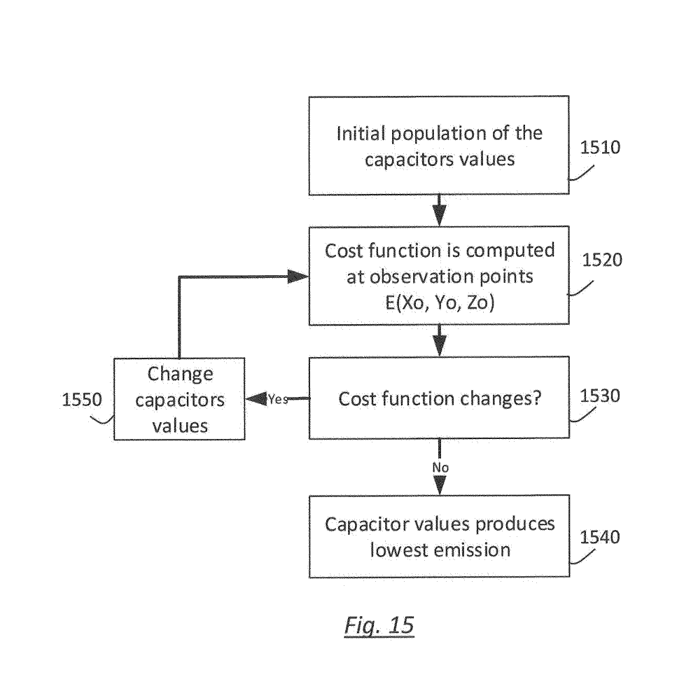

FIG. 15 shows an exemplary flow diagram or algorithm showing an optimization algorithm according to one embodiment of the disclosure. The algorithm starts at step 1510 with selecting arbitrary initial population. In one embodiment, the initial values of capacitors can be selected to be equal to series tuning cap of whole spiral coil multiply by number of in line raps intended to add.

At step 1520, the algorithm computes the cost function of the selected population by solving the coil structure by MoM and summing the magnitude of E-Field along observation point.

The algorithm keeps changing the optimization variables (i.e. capacitors values) while keeping track of the cost function at step 1530. The process is continued until the optimization reaches an end by finding the values of the capacitors that produces the minimum cost function. These steps are show in steps 1530 and 1550. The end, at step 1540, is reached when the reduction in the cost function is no longer significant.

The following are provided to illustrate exemplary and non-limiting embodiments of the disclosure. Example 1 is directed to a transmitter charging station, comprising: a length of conductive wire to form a multi-turn spiral coil having one or more turns around one or more axis: a plurality of discrete capacitors for each of the respective plurality of turns; and wherein at least two of the plurality of capacitors are configured to have substantially the same resonance frequency.

Example 2 is directed to the transmitter charging station of example 1, wherein a first of the plurality of capacitors along a first portion of the multi-turn spiral coil is configured to have substantially the same resonance frequency as a second of die plurality of capacitors along with a second portion of the multi-turn spiral coil. The first or the second portion of the coil may define a turn of the coil of the multi-turn spiral coil or it may define a first and a second portions of the length of the conductive wire.

Example 3 is directed to the transmitter charging station of example 1, wherein at least two of the plurality of the capacitors are linearly aligned along a plane of the cross section of the spiral coil.

Example 4 is directed to the transmitter charging station of example 1, wherein at least one of the plurality of capacitors has a different capacitance value than the remaining capacitors.

Example 5 is directed to the transmitter charging station of example 1, wherein each of the plurality of capacitors have substantially the same capacitance value.

Example 6 is directed to the transmitter charging station of example 1, wherein the capacitance values for the plurality of capacitors are selected to minimize near field electric field above a surface of the spiral coil.

Example 7 is directed to the transmitter charging station of example 1, wherein the plurality of capacitors are connected in series.

Example 8 is directed to the transmitter charging station of example 1, wherein at least two of the plurality of capacitors along with their respective portions of the multi-turn spiral coil are configured to have substantially the same resonance frequency.

Example 9 is directed to a method for reducing near field electric field emission of a charging station, the method comprising: providing a length of conductive wire to form a multi-turn spiral coil having m turns around one or more axis positioning n discrete capacitors for each of the respective plurality of turns; and selecting capacitance value for each of n discrete capacitors as a function of the number of the turns in the multi-turn spiral coil and a cost function associated with the plurality of capacitors.

Example 10 is directed to the method of example 9, wherein m and n are integers and wherein m is one of equal, greater or less than n.

Example 11. The method of example 9, further comprising determining a cost function for at least one of the plurality of capacitors at an observation point above the charging station.

Example 12 is directed to the method of example 9, further comprising selecting a first of the discrete capacitors along a first portion of the conductive wire is configured to have substantially the same resonance frequency as a second of the discrete capacitors and a second portion of the conductive wire.

Example 13 is directed to the method of example 9, wherein at least one of the plurality of capacitors has a different capacitance value than others.

Example 14 is directed to the method of example 9, wherein the plurality of capacitors have substantially the same capacitance value.

Example 15 is directed to the method of example 8, further comprising aligning at least two of the plurality of the capacitors along a plane of the cross section of the spiral coil.

Example 16 is directed to the method of example 9, wherein the total capacitive value for the plurality of capacitors is selected to minimize near field electric field above a surface of the spiral coil.

Example 17 is directed to a wireless charging station, comprising a length of conductive wire to form a multi-turn spiral coil having a plurality of turns around one or more axis; and a plurality of tuning elements positioned along the length of the conductive wire to correspond to each of the plurality of coil turns to resonate the multi-turn spiral coil.

Example 18 is directed to the wireless charging station of example 17, further comprising a first electrode and a second electrode to communicate current to the length of conductive wire.

Example 19 is directed to the wireless charging station of example 17, wherein at least one of the tuning elements comprises a capacitive element.

Example 20 is directed to the wireless charging station of example 17, wherein each tuning element defines a capacitive element and wherein each tuning element resonates each coil turn individually.

Example 21 is directed to the wireless charging station of example 17, wherein a first of the plurality of tuning elements and a first portion of the multi-turn spiral coil is configured to have substantially the same resonance frequency as a second of the plurality of tuning elements and the second portion of the multi-turn spiral coil.

Example 22 is directed to the wireless charging station of example 17, wherein at least two of the plurality of tuning elements are connected in series and are linearly aligned along a plane of the cross section of the spiral coil.

Example 23 is directed to the wireless charging station of example 17, wherein at least one of the tuning elements has a different capacitance value than another tuning element.

Example 24 is directed to the wireless charging station of example 17, wherein each of the plurality of tuning elements have substantially the same capacitance value.

Example 25 is directed to the wireless charging station of example 24, wherein capacitance values for the plurality of tuning elements is selected to minimize a near field electric field above a surface of the wireless charging station.

While the principles of the disclosure have been illustrated in relation to the exemplary embodiments shown herein, the principles of the disclosure are not limited thereto and include any modification, variation or permutation thereof.

What is claimed is:

1. A transmitter charging station, comprising:
a length of conductive wire to form a multi-turn spiral coil having one or more turns around one or more axis;
a plurality of discrete capacitors for each of the respective plurality of turns; and
wherein at least two of the plurality or capacitors are configured to have substantially the same resonance frequency.

2. The transmitter charging station of claim 1, wherein a first of the plurality of capacitors along a first portion of the multi-turn spiral coil is configured to have substantially the same resonance frequency as a second of the plurality of capacitors along with a second portion of the multi-turn spiral coil.

3. The transmitter charging station of claim 1, wherein at least two of the plurality of the capacitors are linearly aligned along a plan of the cross section of the spiral coil.

4. The transmitter charging station of claim 1, wherein at least one of the plurality of capacitors has a different capacitance value than the remaining capacitors.

5. The transmitter charging station of claim 1, wherein each of the plurality of capacitors have substantially the same capacitance value.

6. The transmitter charging station of claim 1, wherein the capacitance values for the plurality of capacitors are selected to minimize near field electric field above a surface of the spiral coil.

7. The transmitter charging station of claim 1, wherein the plurality of capacitors are connected in series.

8. The transmitter charging station of claim 1, wherein at least two of the plurality of capacitors along with their respective portions of the multi-turn spiral coil are configured to have substantially the same resonance frequency.

9. A method for reducing near field electric field emission of a charging station, the method comprising:
providing a length of conductive wire to form a multi-turn spiral coil having m turns around one or more axis;
positioning n discrete capacitors for each of the respective plurality of turns; and
selecting capacitance value for each of a discrete capacitors as a function of the number of the turns (m) in the multi-turn spiral coil and a cost function associated with the plurality of capacitors.

10. The method of claim 9, wherein m and n are integers and wherein m is one of equal, greater or less than n.

11. The method of claim 9, further comprising determining a cost function for at least one of the plurality of capacitors at an observation point above the charging station.

12. The method of claim 9, further comprising selecting a first of the discrete capacitors along a first portion of the conductive wire is configured to have substantially the same resonance frequency as a second of the discrete capacitors and a second portion of the conductive wire.

13. The method of claim 9, wherein at least one of the plurality of capacitors has a different capacitance value than others.

14. The method of claim 9, wherein the plurality of capacitors have substantially the same capacitance value.

15. The method of claim 8, further comprising aligning at least two of the plurality of the capacitors along a plane of the cross section of the spiral coil.

16. The method of claim 9, wherein the total capacitive value for the plurality of capacitors is selected to minimize near field electric field above a surface ash the spiral coil.

17. A wireless charging station, comprising;
a length of conductive wire to form a multi-turn spiral coil having a plurality of turns around one or more axis: and
a plurality of tuning elements positioned along the length of the conductive wire to correspond to each of the plurality of coil turns to resonate the multi-turn spiral coil.

18. The wireless charging station of claim 17, further comprising a first electrode and a second electrode to communicate current to the length of conductive wire.

19. The wireless charging station of claim 17, wherein at least one or be tuning elements comprises a capacitive element.

20. The wireless charging station of claim 17, wherein each tuning element defines a capacitive element and wherein each tuning element resonates each coil turn individually.

21. The wireless charging station of claim 17, wherein a first of the plurality of tuning elements and a first portion of the multi-turn spiral coil is configured to have substantially the same resonance frequency as a second of the plurality of tuning elements and the second portion of the multi-turn spiral coil.

22. The wireless charging station of claim 17, wherein at least two of the plurality of tuning elements are connected in series and are linearly aligned along a plane of the cross section of the spiral coil.

23. The wireless charging station of claim 17, wherein at least one of the tuning elements has a different capacitance value than another tuning element.

24. The wireless charging station of claim 17, wherein each of the plurality of tuning elements have substantially the same capacitance value.

25. The wireless charging station of claim 24, wherein capacitance values for the plurality of tuning elements is selected to minimize a near field electric field above a surface of the wireless charging station.
